(19) United States
(12) Patent Application Publication
(10) Pub. No.: US 2013/0065043 A1
(43) Pub. Date: Mar. 14, 2013

(54) CUSHIONED FOAM MAT WITH POROUS BACKING

(71) Applicant: Paola Teran, Acworth, GA (US)

(72) Inventor: Paola Teran, Acworth, GA (US)

(21) Appl. No.: 13/230,538

(22) Filed: Sep. 12, 2011

(51) Int. Cl. B32B 3/26

(52) U.S. Cl. 428/316.6

(57) ABSTRACT

Embodiments of the present invention are directed to a cushioning mat with a porous backing. The cushioning mat may include a surface layer of face fabric, a layer of open-cell, viscoelastic foam, and a backing in the form of a porous underlay. The porous underlay may have openings through which water penetrating the cushioning mat can escape. The porous underlay may be PVC-coated polyester. Additionally, a layer of jersey knit cloth may be interposed between the porous underlay and the layer of open-cell, viscoelastic foam to promote bonding properties.

### FIELD OF THE INVENTION

The present invention relates generally to cushioned mats for bathroom, kitchen and other uses, and in particular to cushioned mats with enhanced drying properties.

### BACKGROUND OF THE INVENTION

Mats are often placed on bathroom and kitchen floors to absorb water and to provide a comfortable standing surface. For example, bath mats are placed beside showers or bathtubs to absorb water when the user exits and dries off. Similarly, mats can also be placed in front of bathroom or kitchen sinks to absorb water that would otherwise splash on the floor. These mats may include some type of non-skid backing to create traction against the surface and protect against slippage.

Since standing on hard surfaces can be uncomfortable, and it is known that adding a foam cushioning layer in the mats can enhance a user's comfort. U.S. Patent Application Pub. No. 2011/0143083 to Scorgie (“the '083 application”) discloses such a cushioned mat. The cushioned mat of the '083 application includes a layer of absorbent woven textile material over the foam cushioning layer. The woven textile material is formed of a “quick drying” material which acts to wick moisture away from the foam cushioning layer so that the foam cushioning layer can dry out even in wet/humid environments such as bathrooms. A rubberized base material such as one made from a sheet of styrene butadiene rubber (SBR) is glued to the underside of the foam cushioning layer.

However, the rubber sheet used for the base material is impermeable to water and typically covers the entire base of the mat. Therefore, water that penetrates and is absorbed by the cushioning layer has limited avenues for escaping the mat, and the mat becomes difficult to dry properly. Furthermore, since water from the cushioning layer can only escape the mat through the top, the “quick drying” material must be used for the surface layer, limiting the use of other more conventional fabrics such conventional cotton terry or polyester woven material. Aside from simply being unpleasant to the touch, wet mats are susceptible to breeding bacteria.

Accordingly, there is a need in the art for a cushioned mat with enhanced drying properties.

### BRIEF SUMMARY OF THE INVENTION

These and other advantages are provided by a cushioning mat that comprises a face fabric for coming into contact with the user; a foam layer secured to the face fabric, characterized in that the foam layer includes an open cell, viscoelastic foam material; and a backing secured to the foam layer opposite the face fabric for reducing slippage of the cushioning mat, wherein the backing is formed with openings for allowing any water in the foam layer to leave the mat at least partially through the openings.

Advantageously, the cushioning mat may comprise a cloth layer interposed between the backing and the foam layer to promote bonding. According to various embodiments of the invention, the cloth layer may be comprised of jersey knit material.

The openings in embodiments of the present invention may comprise at least 30 percent of the surface area of the backing. In various embodiments, the openings may comprise up to 45 percent of the surface area of the backing. The openings in one embodiment may comprise approximately 40 percent of the surface area of the backing.

The backing in embodiments of the present invention may comprise a sheet of woven fibers coated with a slip-resistant substance. In various embodiments, the woven fibers may be polyester and the slip-resistant substance may be PVC. In other embodiments, the slip-resistant substance may be urethane.

The viscoelastic foam according to embodiments of the present invention is viscoelastic polyurethane foam with a density of approximately 50 kg/m². The foam layer may be bonded with the face fabric using an adhesive. Similarly, the cloth layer may also be bonded to the backing with an adhesive, such as a polyurethane-based or a water-based adhesive.

The average thickness of the foam layer in embodiments of the present invention may be approximately 15 millimeters.

The face fabric, the foam layer, and the backing may be collectively stitched together in various embodiments. The stitching according to one embodiment may be in a quilted configuration.

### BRIEF DESCRIPTION OF THE DRAWINGS

Having thus described the invention in general terms, reference will now be made to the accompanying drawings, which are not necessarily drawn to scale, and wherein:

FIG. 1 is a schematic illustration of a cross-section of a bath mat according to an embodiment of the present invention; and

FIG. 2 is a close-up view of a section of the porous backing according to embodiments of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

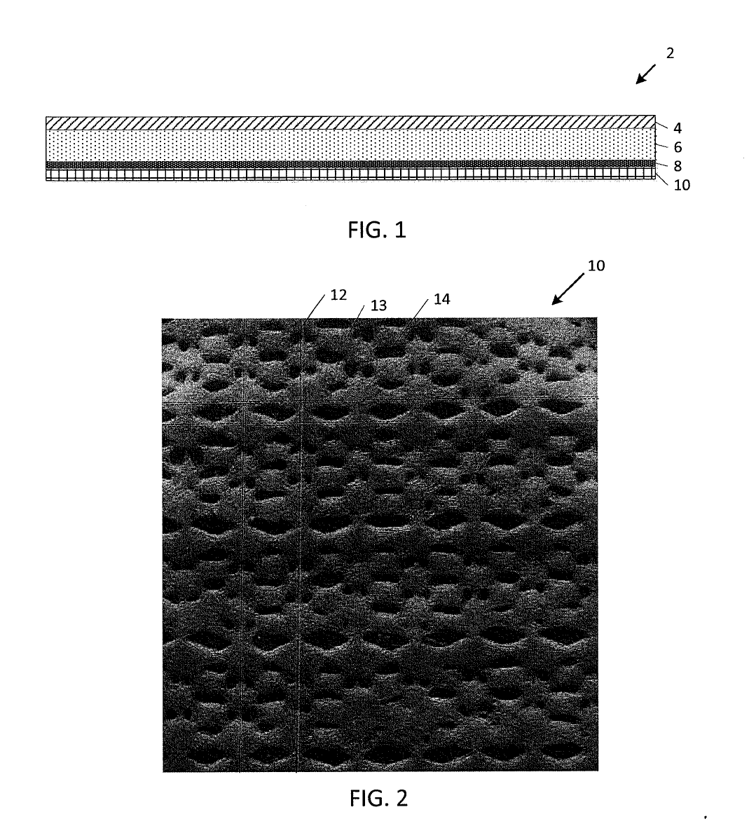

FIG. 1 shows a schematic view illustrating in cross-section a cushioned mat 2 according to an embodiment of the present invention. The cushioned mat 2 is a layered structure having a top layer of face fabric 4, a foam layer 6, and a porous backing 10. In the illustrated embodiment, the cushioned mat 2 also has a cloth 8 interposed between the foam layer 6 and the porous backing 10.

### Face Fabric

The face fabric 4 forms the top surface of the cushioned mat 2 and is therefore designed for direct exposure to the elements. In the present embodiment, for example, the cushioned mat 2 is provided for use in a bathroom where it will be exposed to moisture and general wear and tear from daily use. As such, the face fabric 4 in the present embodiment is formed from conventional fabric material such as a knit polyester material. However, other fibers can be used including cotton, and the fabric can comprise conventional woven, chenille or other constructions. The fabric can be formed in various weights, such as from 250-450 gsm, and can have pile heights from 3-40 mm.

In other embodiments, the face fabric 4 may be formed from a high-absorbency fabric. However, various other materials can be used for the face fabric 4 and may be selected or pre-treated based on factors such as durability, softness, anti-bacterial properties, etc.

### Foam Layer

Underneath the face fabric 4 is a foam layer 6, which enhances the comfort of the user standing on the cushioned mat 2 by counteracting pressure from hard floor surfaces such as those conventionally found in bathroom or kitchen facilities.

In an example embodiment, the foam layer 6 is formed of open-cell viscoelastic polyurethane foam (i.e., memory foam). Given its open-cell construction, the viscoelastic polyurethane foam absorbs and retains water and does not easily let the water evaporate.

In various other embodiments, the foam layer 6 can be formed of any of a variety of compressible materials. The foam layer 6 in the present embodiment has a thickness of approximately 15 mm and a density of approximately 50 kg/m². However, the thickness and density of the foam layer 6 may vary depending on intended use. For example, mats for use adjacent to bathroom or kitchen sinks may have more cushioning than mats used adjacent to a shower or bathtub, due to the relative feel desired.

The foam layer 6 in the present embodiment of the invention comprises a single layer of foam. However, in other embodiments, the foam layer 6 may be a composite of multiple foam layers. For example, foams of various densities and/or thicknesses may be secured together to produce an enhanced cushioning effect.

As shown in FIG. 1, the face fabric 4 is attached to the foam layer 6. In the present embodiment, the face fabric 4 is laminated to the foam layer 6 using a polyurethane-based adhesive. However, in other embodiments, various other types of adhesives, including water-based adhesives, may be used for lamination. Alternatively, the face fabric 4 may be stitched to the foam layer 6, in addition to, or in lieu of, lamination.

### Cloth

As shown in FIG. 1, the cloth 8 is interposed between the foam layer 6 and the porous backing 10. In the present embodiment, the cloth 8 is a jersey knit formed of 40-50 denier polyester, having a weight of approximately 40 gsm. In various other embodiments, the cloth 8 may be formed of other fabrics, such as felt or other nonwoven fabrics. The cloth 8 is laminated to the foam layer 6 using an adhesive in order to provide a more effective bonding surface when attaching the porous backing 10. Therefore, depending on the relative bonding properties of the materials used, certain other embodiments may not have a layer of cloth interposed between the foam layer and the backing. Furthermore, the cloth 8 may be laminated to the foam layer 6 before attaching the porous backing 10, in other embodiments the foam layer 6 may be laminated to the cloth 8 and the porous backing 10 in one step.

### Porous Backing

The porous backing 10 forms the bottom surface of the cushioned mat 2 and provides resistance against slippage. In addition, the porous backing 10 serves to protect the viscoelastic polyurethane foam layer 6 from abrasion and other damage such as might occur during regular use or washing of the cushioned mat. FIG. 2 shows a close-up view of a small section of the porous backing 10 according to an embodiment of the present invention. As shown in FIG. 2, the porous backing 10 is comprised of a loosely woven scrim 12 for which the filaments have been covered in a non-slip coating 13. In the present embodiment, the scrim 12 is woven from polyester fibers, and the non-slip coating 13 is PVC. However, in other embodiments, other materials may be used for either the scrim 12 or the non-slip coating 13. For example, in some embodiments, the non-slip coating 13 may be formed from urethane. Further, depending on the parameters of the foam layer 6 (e.g., thickness, cell size etc), other materials could be used for the backing that provide a sufficient balance of porosity, abrasion protection, and anti-slip capabilities.

The non-slip coating 13 does not fully coat the surface of the scrim 12 but rather leaves openings 14 of various shapes and sizes spaced throughout the surface. The sizes of the openings 14 may vary in different embodiments depending on the density of the scrim 12 and the thickness of the non-slip coating 13. In the present embodiment, the non-slip coating 13 comprises approximately 60 percent of the surface of the porous backing 10, and the openings 14 comprise the remaining approximately 40 percent. The porous backing 10 in this embodiment has a weight of approximately 180 gsm.

In other embodiments, approximately 55-70 percent of the surface of the porous backing 10 may be comprised of the non-slip coating 13, with the openings 14 comprising the remaining percent. Accordingly, the openings 14 may comprise as much as 45 percent or as little as 30 percent in various embodiments.

As such, water that has penetrated the foam layer 6, whether through normal use or washing, can leave the cushioning mat 2, such as by evaporation, at least partially through the openings 14 in the porous backing 10. Water may also leave the cushioning mat 2 through the face fabric 4.

In an example embodiment, the porous backing 10 is attached to the cloth 8 after the cloth 8 has been laminated to the foam layer 6 opposite the face fabric 4. The porous backing 10 can be laminated to the cloth 8 and foam layer 6 using a polyurethane-based adhesive. However, in other embodiments, various other types of adhesives, including water-based adhesives, may be used.

The face fabric 4, foam layer 6, and the cloth 8 may first be stitched together, and then the porous backing 10 may be attached to the cloth 8. The porous backing 10 may be attached through the same lamination method described above in attaching the face fabric 4 to the foam layer 6. In various embodiments, the porous backing 10 may also be stitched to the other layers, in addition to, or in lieu of, lamination. In various embodiments, the face fabric 4, the foam layer 6, and the porous backing 10 may be collectively stitched together in a quilted configuration. A quilted appearance or other pattern or design, such as a logo, may be provided by embossing the face fabric 4 and foam layer 6 through the application of heat and pressure.

In embodiments without the cloth 8, the backing 10 may be attached directly to the foam layer 6. This attachment may be accomplished through conventional lamination or stitching methods.

Once the porous backing 10 is attached, binding tape (not shown) may be sewn along the perimeter of the cushioning mat 2 to secure the face fabric 4, foam layer 6, the cloth 8, and the porous backing 10 in place.

### CONCLUSION

Many modifications and other embodiments of the present invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A cushioning mat for cushioning a user in environments where water can come into contact with the cushioning mat, the cushioning mat comprising:
a face fabric for coming into contact with the user;
a foam layer secured to a surface of the face fabric, wherein the foam layer includes an open cell, viscoelastic foam material; and
a backing secured to the foam layer opposite the face fabric for reducing slippage of the cushioning mat, wherein the backing is formed with openings for allowing any water in the foam layer to leave the mat at least partially through the openings in the backing.

2. The cushioning mat of claim 1, wherein a cloth layer is interposed between the backing and the foam layer to promote bonding.

3. The cushioning mat of claim 2, wherein the cloth layer is comprised of jersey knit material.

4. The cushioning mat of claim 1, wherein the openings comprise at least 30 percent of the surface area of the backing.

5. The cushioning mat of claim 1, wherein the backing comprises a sheet of woven fibers coated with a slip-resistant substance.

6. The cushioning mat of claim 5, wherein the woven fibers are polyester and the slip-resistant substance is PVC.

7. The cushioning mat of claim 5, wherein the slip-resistant substance comprises urethane.

8. The cushioning mat of claim 1, wherein the viscoelastic foam is viscoelastic polyurethane foam.

9. The cushioning mat of claim 8, wherein the viscoelastic polyurethane foam has a density of approximately 50 kg/m².

10. The cushioning mat of claim 1, wherein the foam layer is bonded to the face fabric with an adhesive.

11. The cushioning mat of claim 2, wherein the cloth layer is bonded to the backing with an adhesive.

12. The cushioning mat of claim 2, wherein the cloth layer is laminated to the foam layer.

13. The cushioning mat of claim 1, wherein the average thickness of the foam layer is approximately 15 millimeters.

14. The cushioning mat of claim 1, wherein the face fabric, the foam layer, and the backing are collectively stitched together.

15. The cushioning mat of claim 15, wherein the face fabric, the foam layer, and the backing are collectively stitched together in a quilted configuration.

16. The cushioning mat of claim 10, wherein the adhesive is water-based.

17. The cushioning mat of claim 10, wherein the adhesive is polyurethane-based.

18. The cushioning mat of claim 11, wherein the adhesive is water-based.

19. The cushioning mat of claim 11, wherein the adhesive is polyurethane-based.

20. The cushioning mat of claim 4, wherein the openings comprise approximately 40 percent of the surface area of the backing.

21. The cushioning mat of claim 4, wherein the openings comprise up to 45 percent of the surface area of the backing.
